(19) United States
(12) Patent Application Publication
(10) Pub. No.: US 2015/0364874 A1
(43) Pub. Date: Dec. 17, 2015

(54) CONNECTOR DEVICE

(71) Applicant: Samsung Electronics Co., Ltd., Gyeonggi-do (KR)

(72) Inventors: Kyung-Woo LIM, Gyeonggi-do (KR); Chan-Jung BAE, Gyeonggi-do (KR)

(73) Assignee: Samsung Electronics Co., Ltd.

(21) Appl. No.: 14/739,797

(22) Filed: Jun. 15, 2015

(30) Foreign Application Priority Data
Jun. 13, 2014 (KR) 10-2014-0072415

(51) Int. Cl. H01R 13/713

(52) U.S. Cl. CPC H01R 13/7137

(57) ABSTRACT

A connector device connectable to an electronic device is provided. The connector device includes a body housing, a cap unit coupled to the body housing, and a cable electrically connected to the body housing and the cap unit. The cap unit is provided with a terminal protection module that senses a temperature due to heat generated when the body housing and the cable are electrically connected, and disconnects the electrical connection.

### PRIORITY

This application claims priority under 35 U.S.C. §119(a) to Korean Application Serial No. 10-2014-0072415, which was filed in the Korean Intellectual Property Office on Jun. 13, 2014, the entire content of which is incorporated herein by reference.

### BACKGROUND

1. Field of the Disclosure

The present disclosure relates generally to a connector device used by being connected with an electronic device.

2. Description of the Related Art

Various electronic devices, such as a portable phone, an MP3 player, a portable multimedia player (PMP), a tablet PC, a Galaxy Tab, a smart phone, an I-Pad, and an e-book terminal are available for users to access various contents while carrying the various electronic devices.

In addition, data services for transmitting/receiving data are provided when an electronic device is connected to a computer, an external device, or the like by a cable. The cable may be electrically connected with a charger that provides electric power to charge the electronic device.

When a charging circuit board is embedded in the charger, an output terminal unit and an input terminal unit are provided. The input terminal unit is connected to a power supply socket, and the output terminal unit is connected to a charging terminal provided in an electronic device so as to charge the electronic device.

In addition, a plug is provided at one end of the input terminal unit to connect with the socket, and a connector device compatible with the charging terminal of the electronic device is provided at one end of the output terminal unit.

However, foreign matter can enter into the connector device when charging the electronic device due to a deformation of the connector device, causing a short circuit between power lines or generating heat due to the increased resistance, thereby causing an unwanted situation.

In addition, an existing connector device may be provided in a temperature sensor and a cut-off circuit therein, to sense and suppress heat. Thus, problems arise due to a complicated assembly process, the size of the connector device increases, and the cost to manufacture the connector device increases.

### SUMMARY

The present disclosure has been made to address at least the problems and disadvantages described above, and to provide at least the advantages described below. Accordingly, an aspect of the present disclosure is to provide a device within a connector device that senses abnormal generation of heat to disconnect the electrical connection.

Another aspect of the present disclosure provides a connector device adapted to prevent the damage to a product and improve the reliability of the product by configuring a terminal protection module that senses a temperature generated in a state where a body housing and a cable is electrically connected to a cap unit, and cuts off an electrical connection.

Another aspect of the present disclosure provides a connector device adapted to prevent the damage to a product and improve the reliability of the product by configuring a terminal protection module that senses a temperature within a body housing and at the same time, cut off the electrical connection.

Another aspect of the present disclosure provides a connector device which is capable of reducing the number of parts of a product to simplify an assembly process of the product, reducing the size of the product to miniaturize the product, and reducing the manufacturing cost of the product by configuring a terminal protection module within a cap unit or a body housing which senses a temperature within a body housing and at the same time, cut off the electrical connection so that the existing temperature sensor and the cut-off circuit are not needed.

In accordance with an aspect of the present disclosure, a connector device that is connectable to an electronic device is provided. The connector device includes a body housing, a cap unit coupled to the body housing, a cable electrically connected to the body housing and the cap unit, and a terminal protection module that is configured to disconnect the electrical connection with the electronic device based on a sensed temperature of an electrical connection of the body housing and the cable.

In accordance with another aspect of the present disclosure, a connector device that is connectable to an electronic device is provided. The connector device includes a body housing provided with first and second contact terminals configured to connect with the cable, a cap unit coupled to the body housing and configured to connect with the cable, and a terminal protection module that includes first and second connection terminals electrically connected with the first and second contact terminals. The terminal protection module cuts off the electrical connection based on a temperature of the electrical connection of the body housing and the cable.

In accordance with another aspect of the present disclosure, connector device that is connectable with an electronic device is provided. The connector device includes a body housing provided with first and second contact terminals configured to connect with the cable, a cap unit coupled to the body housing and configured to connect with the cable. The body housing is provided with a terminal protection module including first and second connection terminals electrically connected with the first and second contact terminals. The terminal protection module cuts off the electrical connection based on a temperature generated when the body housing and the cable are electrically connected with each other.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a perspective view illustrating a front face of an electronic device according to an embodiment of the present disclosure;

FIG. 2 is a perspective view illustrating a rear face of an electronic device according to an embodiment of the present disclosure;

FIG. 3 is an exploded perspective view illustrating a configuration of a connector device according to an embodiment of the present disclosure;

FIG. 4 illustrates an inner configuration of a connector device according to an embodiment of the present disclosure;

FIG. 5 illustrates another arrangement of the terminal protection module in the configuration of the connector device according to an embodiment of the present disclosure;

FIG. 6 illustrates another embodiment of a terminal protection module in the configuration of the connector device;

FIG. 7 illustrates another embodiment of first and second contact terminals of the body housing in the configuration of the connector device according to an embodiment of the present disclosure;

FIG. 8 illustrates another embodiment of the connector device according to the present disclosure;

FIG. 9 illustrates another arrangement of the terminal protection module in the configuration of another embodiment of the connector device according to the present disclosure;

FIG. 10 illustrates still another embodiment of the connector device according to the present disclosure; and

FIG. 11 illustrates yet another embodiment of the connector device according to the present disclosure.

### DETAILED DESCRIPTION

Hereinafter, embodiments of the present disclosure will be described in detail. Terms used in the embodiments of the present disclosure will be briefly described.

With respect to the terms in the embodiments of the present disclosure, the general terms which are currently and widely used are selected in consideration of functions of structural elements in the embodiments of the present disclosure. However, meanings of the terms may be changed according to a judicial precedent, appearance of a new technology, and the like. Further, in certain cases, terms arbitrarily selected may be used. In such a case, the meaning of the term will be described in detail at the corresponding part in the description of the present disclosure. Thus, the terms used in various embodiments of the present disclosure should be defined based on the meanings of the terms and the overall contents of the embodiments of the present disclosure instead of simple titles of the terms.

Although the terms including an ordinal number such as first, second, etc. can be used to describe various elements, the structural elements are not restricted by the terms. The terms are used merely for the purpose to distinguish an element from other elements. For example, a first element could be referred to as a second element, and similarly, a second element could be also referred to as a first element without departing from the scope of the present disclosure.

According to various aspects of the present disclosure, by configuring the terminal protection module in the cap unit or the body housing to sense a temperature and cut off an electrical connection, damage of the connector device and the cable can be prevented. Further, reliability and quality of the connector device and the cable can be enhanced, and better protection is provided to the electronic device connected with the connector device and the cable.

In addition, since the existing temperature sensor and cut-off circuit are not needed, the number of parts of the connector device is reduced to simplify the assembly process of the connector device, the size of the connector device can be reduced to miniaturize the connector device, and the manufacturing cost can be reduced.

Descriptions are provided based on an electronic device that connects to a connector device according to embodiments of the present disclosure. Examples of applications of the electronic device may include all the information communication devices such as a video phone, an e-book reader, a laptop PC, a netbook computer, a personal digital assistant (PDA), a portable multimedia player (PMP), an MP3 (MPEG-1 audio layer-3) player, a mobile medical device, a camera, a wearable device, e.g., a head-mounted-device (HMD) such as electronic spectacles, electronic clothes, an electronic wristlet, an electronic necklace, an appcessory, electronic tattoos, or a smart watch, and applications thereof, as well as all the mobile communication terminals operated based on communication protocols corresponding to various communication systems.

The electronic device may further include a smart home appliance, e.g., a television, a digital video disk (DVD) player, a refrigerator, an air conditioner, a vacuum cleaner, an oven, a microwave oven, a washing machine, an air cleaner, a set-top box, a TV box, e.g., Samsung HomeSync™, Apple TV™, or Google TV™, a game console, an electronic dictionary, an electronic key, a camcorder, and an electronic photo frame.

The electronic device may also include a medical device, e.g., a magnetic resonance angiography (MRA), a magnetic resonance imaging (MRI), a computed tomography (CT) machine, and an ultrasonic machine. The electronic device may also include navigation devices, e.g., a global positioning system (GPS), an event data recorder (EDR), a flight data recorder (FDR), a vehicle infotainment device, a ship-board electronic navigation device such as a gyro-compass, an avionic device, a security device, an automotive head unit, a robot for home or industry, a bank automatic teller machines (ATM), or a merchant point of sales (POS) device.

The electronic device may also include furniture or a part of a building/structure, an electronic bulletin board, an electronic signature receiving device, a projector, and measuring devices, e.g., a water meter, an electric meter, a gas meter, a radio wave meter and the like, including a camera function.

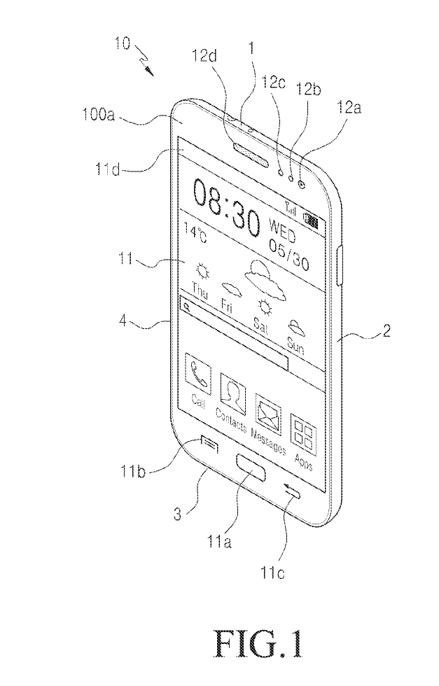

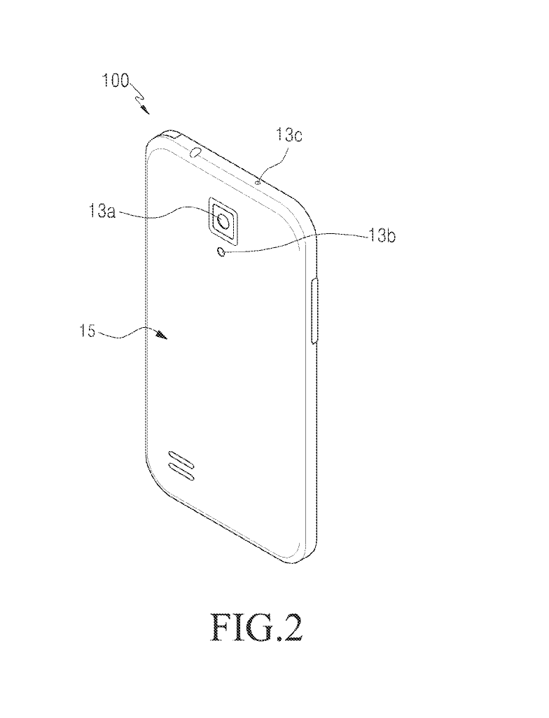

An electronic device according to embodiments of the present disclosure may be a combination of one or more of above described various devices. Also, an electronic device according to embodiments of the present disclosure may be a flexible device. Also, an electronic device according to embodiments of the present disclosure is not limited to the above described devices. FIG. 1 is a perspective view illustrating a front face of an electronic device according to an embodiment of the present disclosure. FIG. 2 is a perspective view illustrating a rear face of an electronic device according to an embodiment of the present disclosure.

As illustrated in FIG. 1, a touch screen 11 is disposed in a front central portion of the electronic device 10. The touch screen 11 occupies most of the front face of the mobile device 10. FIG. 1 illustrates a main home screen displayed on the touch screen 11. The main home screen is the screen that is initially displayed on the touch screen 11 when the mobile device 10 is turned ON. When the electronic device 11 has more than a single page of different home screens, the main home screen is the first home screen among the various different home screen pages. On the home screen, e.g., shortcut icons for executing frequently used applications, a main menu switching key, time, and weather may be displayed. In addition, in an upper end region 1 of the touch screen 11, a status bar 11d that indicates states, such as battery charge status, received signal intensity, and present time, may be formed. In the portion below the touch screen 11, a home key 11a, a menu key 11b, and a back key 11c may be formed, and the right side, bottom and left side of mobile device 10 are indicated by reference numerals 2, 3 and 4, respectively.

The home key 11a may cause the main home screen to be displayed on the touch screen 11. For example, when the home key 11a is touched when a home screen different from the main home screen or a menu screen is displayed on the touch screen 11, the main home screen is displayed on the touch screen 11. In addition, when the home button 11 a is touched while applications are being executed, the main home screen may be displayed on the touch screen 11. In addition, the home button 11a is used to display the recently used applications or a task manager on the touch screen 11. The menu key 11b provides a connection menu on the touch screen 11. The connection menu includes, e.g., a widget addition menu, a background change menu, a retrieve menu, an editing menu, and an environment setting menu. The back button 11c causes the screen that was displayed immediately prior to the currently displayed screen to be displayed or causes the most recently used application to be finished.

According to embodiments of the present disclosure, a first camera 12a, an illuminance sensor 12b, or a proximity sensor 12c are disposed in the upper end region 1 of the front face of the electronic device 10. A second camera 13a, a flash 13b, and a speaker 13c are disposed on a rear face of the mobile device 10. When the electronic device 10 is configured with a detachable battery pack, the rear face of the electronic device 10 includes an attachable/detachable battery cover 15.

In the electronic device to be described below, the battery pack is configured to be attachable/detachable, and thus the battery cover is configured to be assembled to/disassembled from the electronic device.

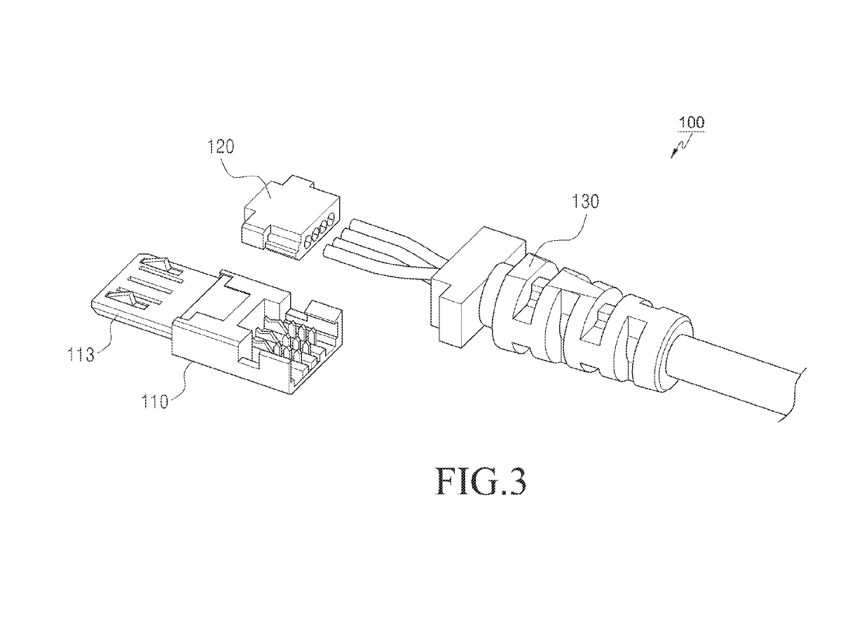

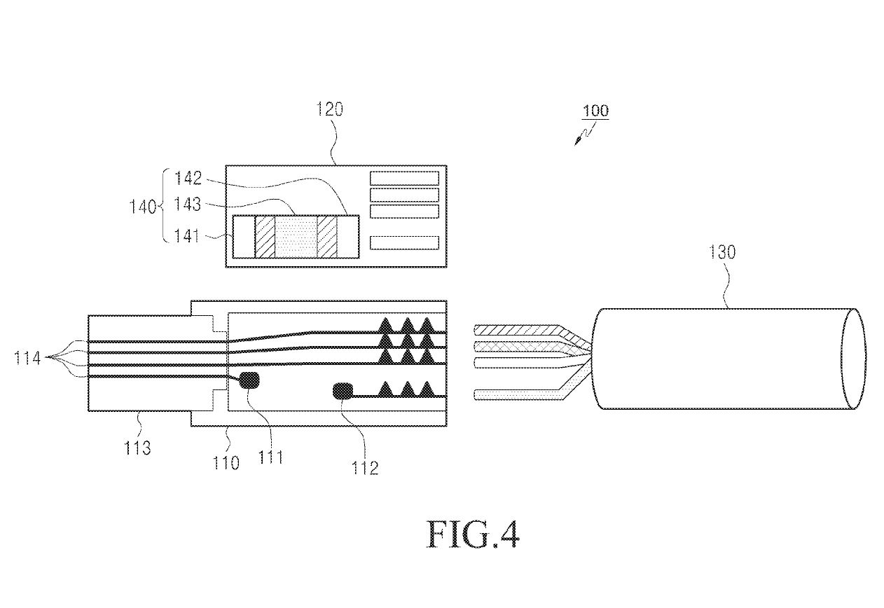

In addition, the battery pack is electrically connected with an external charger (not illustrated) to provide external electric power to charge the electronic device 10. The electronic device 10 is provided with a battery pack, and the charger and battery pack are electrically connected with each other by a connector device 100 (see FIGS. 3 and 4), to supply electric power to the battery pack.

FIG. 3 is an exploded perspective view illustrating a configuration of a connector device according to an embodiment of the present disclosure, and FIG. 4 illustrates an inner configuration of a connector device 100 according to an embodiment of the present disclosure.

Referring to FIGS. 3 and 4, the connector device 100 provides a connection to the electronic device 10, with the connector device 100 including a body housing 110, a cap unit 120, and a cable 130. The body housing 110 is provided with a contact connector 113 that electrically connects with a coupling terminal that is provided in the electronic device 10 (FIG. 1), and includes a plurality of connection lines 114 electrically connected with the cap unit 120 and the cable 130. The connection lines 114 are provided with first and second contact terminals 111 and 112 that electrically connect with first and second connection terminals 141 and 142 provided in the terminal protection module 140, as described herein.

The cap unit 120 is provided with the terminal protection module 140 formed by an in-mold injection molding process and coupled to the body housing 110. The in-mold injection molding refers to a molding method in which injection molding, printing and partial coating processes of a plastic case, which are conventionally performed as individual processes, are integrated in a single injection molding process. That is, the cable 130 is inserted into the cap unit 120 provided with the terminal protection module 140, and the cap unit 120 coupled with the cable 130 is fitted and coupled to the body housing 110.

The terminal protection module 140 is provided with first and second connection terminals 141 and 142, which are electrically connected with the first and second contact terminals 111 and 112, and is provided in the cap unit 120 to cut off the electrical connection simultaneously with sensing an excess temperature due to heat generated at the electrical connection of the body housing 110 and the cable 130.

The terminal protection module 140 includes a terminal protection element 143 to cut off the electrical connection of the first and second connection terminals 141 and 142 simultaneously when an excess temperature due to heat generated from the connector device 100 is sensed.

The terminal protection element 143 may be formed as a positive temperature coefficient (PTC) element.

The PTC element is a semiconductor element formed of a barium titanate-based ceramic, which has a positive coefficient of resistivity, i.e., has an electrical resistance that rapidly increases as temperature increases.

That is, the terminal protection element 143 is a safe heating element capable of replacing a nichrome wire, and provides a switch action in which electrical resistance increases when an excess current flows during a very short time, to avoid flow of excess current.

In the present embodiment, the terminal protection element 143 is described using the PTC element as an example, but is not limited thereto. That is, as for the terminal protection element 143, various elements other than the PTC element are applicable as long as the various other elements are capable of sensing a temperature of heat within the cap unit 120 and, based on the sensed temperature, cutting off the electrical connection.

By configuring the terminal protection module 140 to simultaneously disconnect the first and second connection terminals 141 and 142 based on a simultaneously sensed temperature of the cap unit 120, damage to the connector device 100 and occurrence of a short circuit of the connector device 100 is prevented.

The terminal protection module 140 is arranged in a longitudinal direction of the cap unit 120. That is, the longitudinal direction corresponds to a direction in which the cap unit 120 is elongated.

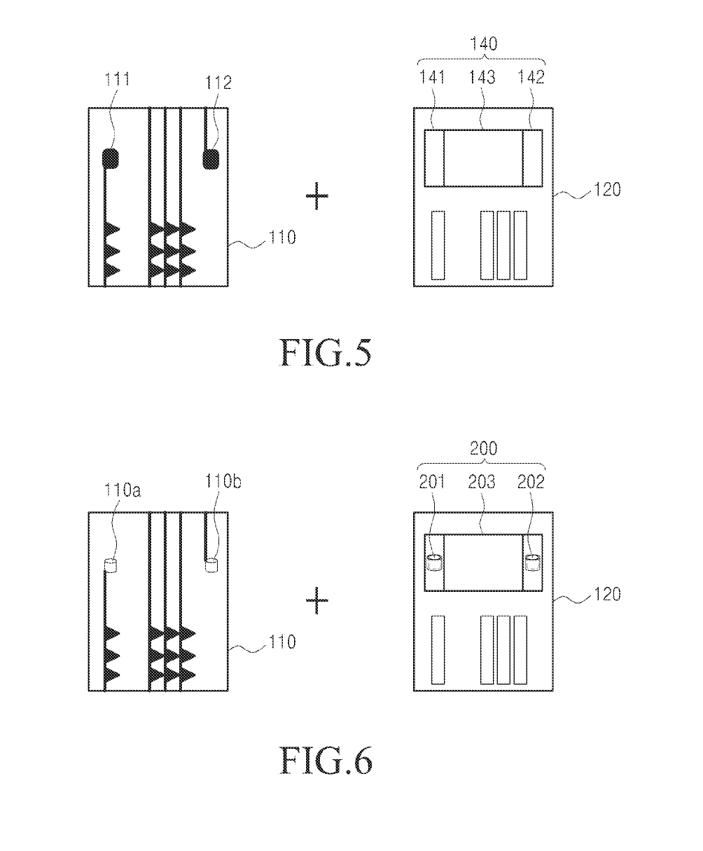

FIG. 5 illustrates another arrangement of the terminal protection module 140 in the configuration of the connector device 100 according to another embodiment of the present disclosure.

As illustrated in FIG. 5, the terminal protection module 140 is arranged in a direction perpendicular to the longitudinal, i.e., lengthwise, direction of the cap unit 120.

That is, the terminal protection module 140 is arranged perpendicular to the longitudinal direction of the cap unit 120, and the first and second contact terminals 111 and 112 of the body housing 110 are arranged to be electrically connected with the first and second connection terminals 141 and 142 of the terminal protection module 140. In other words, the first and second contact terminals 111 and 112 are arranged in the body housing 110 to correspond to the first and second connection terminals 141 and 142 arranged in a direction perpendicular to the longitudinal direction.

FIG. 6 illustrates another embodiment of a terminal protection module 200 in the configuration of the connector device 100.

Referring to FIG. 6, the terminal protection module 200 includes a terminal protection element 203 and the first and second connection terminals 201 and 202 are formed in first and second connection grooves, which are provided in the cap unit 120. The first and second connection terminals 201 and 202 may be formed in first and second connection grooves to be electrically connected simultaneously when fitted and coupled to the first and second terminal projections 110a and 110b provided in the body housing 110.

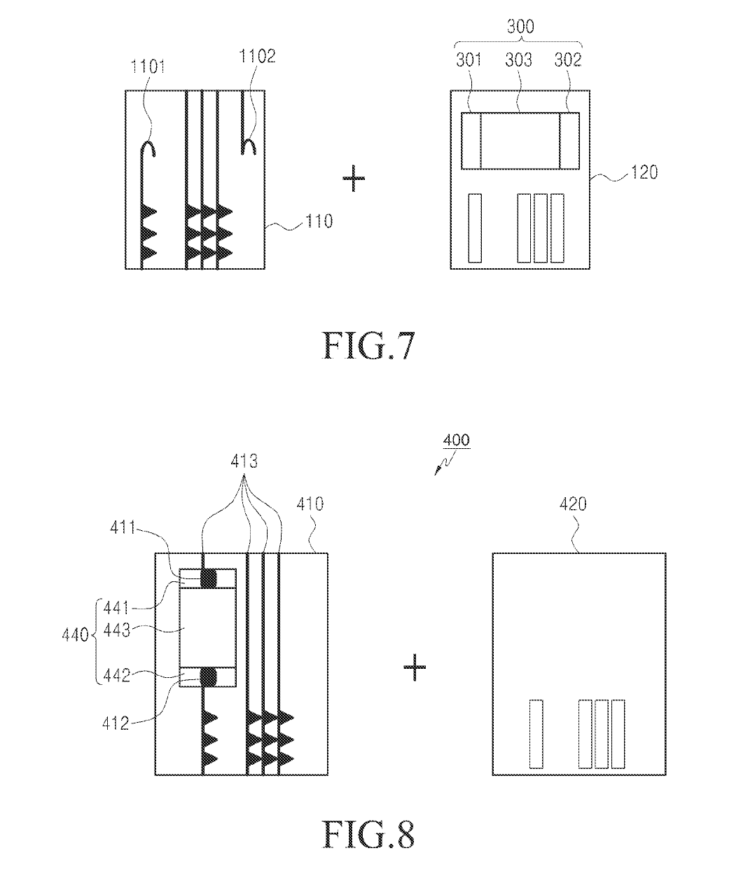

That is, the first and second connection grooves house the first and second connections terminals 201 and 202, which are coupled to the first and second projections 110a and 110b by a press-fitting coupling of the cap unit 120 to the body housing 110. In addition, when the cap unit 120 is separated from the body housing 110, the first and second connection terminals 201 and 202 are released from the first and second terminal projections 110a and 110b. FIG. 7 illustrates another embodiment of first and second contact terminals 1101 and 1102 of the body housing 110 according to an embodiment of the present disclosure.

Referring to FIG. 7, the first and second contact terminals 1101 and 1102 provided in the body housing 110 may be formed as first and second clip-type contact terminals 1101 and 1102 to be electrically connected with the first and second connection terminals 301 and 302 of the terminal protection module 300.

The terminal protection module 300 is provided with a terminal protection element 303 that senses a temperature due to heat generated when the first and second clip-type contact terminals 1101 and 1102 and the first and second connection terminals 301 and 302 are electrically connected with each other and simultaneously cuts off the electrical connection of the first and second connection terminals 301 and 302.

The first and second clip-type contact terminals 1101 and 1102 are electrically connected with the first and second connection terminals 301 and 302 of the cap unit 120 while being compressed by the first and second connection terminals 301 and 302 when the cap unit 120 is coupled to the body housing 110.

The first and second clip-type contact terminals 1101 and 1102 provide elasticity for an improved and simple electrical connection with the first and second connection terminals 301 and 302.

In other words, when the cap unit 120 is coupled to the body housing 110, the first and second clip-type contact terminals 1101 and 1102 come in contact with the first and second connection terminals 301 and 302 of the cap unit 120 and, at the same time, are electrically connected with the first and second connection terminals 301 and 302, while being elastically pressed.

Here, the first and second contact terminals 1101 and 1102 may be formed in other forms different from the first and second clip-type contact terminals 1101 and 1102. For example, the first and second contact terminals 1101 and 1102 may be formed as one of first and second ring-type contact terminals, and first and second leaf spring-type contact terminals. The assembly and operation of the connector device is described with reference to FIGS. 3 and 4. As illustrated in FIG. 3, the connector device 100 includes a body housing 110 provided with first and second contact terminals 111 and 112, a cap unit 120, and a cable 130.

The cable 130 is inserted into the cap unit 120 of the terminal protection module 140. The cap unit 120, into which the cable 130 is inserted, is fitted and coupled to the body housing 110. At this time, the cap unit 120 is coupled to the body housing 110 in a press-fitting manner.

In this state, when a battery pack of the electronic device 10 is charged using a charger, the contact connector 113 of the body housing 110 provided at one end of the cable 130 is coupled to the coupling terminal of the electronic device 10, and a contact connector of another body housing of another connector device provided at the other end of the cable 130 is coupled to the charger.

The electronic device 10 charges the battery pack provided therein using each of the connector devices, which connect to respective ends of a common cable. An abnormal state occurs when a short circuit occurs in the cable 130 or if resistance of components in the route of the cable 130 increases due to foreign matter entering into the connector device 100 or due to deformation of the cable or the resistive components, thereby resulting in excess heat being generated by the connector device 100. When the connector device 100 generates excess heat, the terminal protection module 140 provided in the connector device 100 senses the excess heat and simultaneously cuts off the electrical connection between the body housing 110 and the cable 130.

That is, the terminal protection module 140 is capable of precisely determining when excess heat is generated, to prevent overload.

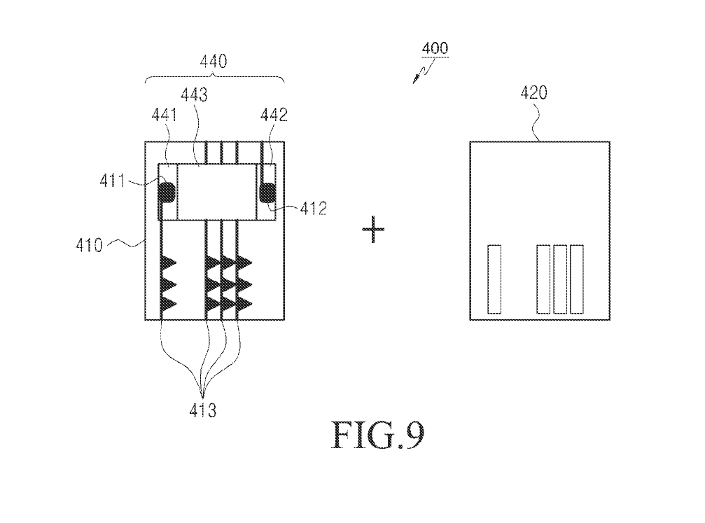

Hereinafter, descriptions will be made on a connector device according to other embodiments of the present invention with reference to FIGS. 8 and 9. In describing the connector device according to other embodiments, the components overlapping those of the connector device 100 according to the aforementioned embodiment of the present invention will not be repeatedly described and only the differences will be described.

As illustrated in FIGS. 8 and 9, a connector device 400, used by being connected to the electronic device 10, includes a body housing 410, a cap unit 420, and a cable. The body housing 410 is provided with a contact connector electrically connected with a coupling terminal provided in the electronic device 10 (see FIG. 1), and is provided with a plurality of connection lines 413 electrically connected with the cap unit 420 and the cable, such as cable 130 described in FIG. 1. The plurality of connection lines 413 are provided with first and second contact terminals 411 and 412 to be electrically connected with first and second connection terminals 441 and 442 provided in the terminal protection module 440.

The cable is inserted into the cap unit 420, and the cap unit 420, coupled with the cable, is fitted and coupled to the body housing 410.

The terminal protection module 440 is provided with the first and second connection terminals 441 and 442 electrically connected with the first and second contact terminals 411 and 412, and is provided in the body housing 410 to sense a temperature due to heat generated when the body housing 410 and the cable are electrically connected with each other and to disconnect the electric connection.

The terminal protection module 440 includes a terminal protection element 443 to cut off the electric connection of the first and second connection terminals 441 and 442 simultaneously with sensing a high temperature generated from the connector device 400.

The terminal protection element 443 may be formed of a PTC thermistor element.

By configuring the terminal protection module 440 to cut off the electric connection of the first and second connection terminals 441 and 442 simultaneously when sensing a high temperature in the body housing 410 as described above, damage to the connector device 400 is prevented, and the occurrence of a short-circuit of the connector device is prevented so that the reliability of a product is further enhanced.

In FIG. 8, the terminal protection module 440 is arranged in the longitudinal direction of the body housing 410.

As illustrated in FIG. 9, the terminal protection module 440 can be arranged in a direction perpendicular to the longitudinal direction of the body housing 410.

That is, in FIG. 9 the terminal protection module 440 is arranged in the direction perpendicular to the longitudinal direction of the body housing 410, the first and second contact terminals 411 and 412 are arranged to be electrically connected with the first and second connection terminals 441 and 442 of the terminal protection module 440. In other words, the first and second contact terminals 411 and 412 are arranged in the body housing 410 to correspond with the first and second connection terminals 441 and 442 provided in the terminal protection module 440 arranged in the direction perpendicular to the longitudinal direction.

Here, descriptions will be made on the assembly and operation of the connector device 400 with reference to FIG. 8 described above. First, as illustrated in FIG. 8, the connector device 400 includes a body housing 410 provided with first and second contact terminals 411 and 412, a terminal protection module 440, and a cap unit 420, for connection with a cable.

The cable is to be inserted into the cap unit 420. The cap unit 420, into which the cable is inserted, is fitted and coupled to the body housing 410. At this time, the cap unit 420 is coupled to body housing 410 in a pressing manner.

Here, the terminal protection module 440 is provided in the body housing 410 through an in-mold injection molding process.

In this state, when a battery pack of electronic device 10 is charged using a charger, the contact connector of the body housing 410 of one connector device provided in one end of the cable is coupled to the terminal of the electronic device 10, and the contact connector of the body housing 410 of another connector device provided in the other end of the cable is coupled to the charger.

The electronic device 10 charges the battery pack provided in the electronic device 10 using each connector device.

When charging the electronic device 10 and the charger, the connector device 400 generates a high temperature due to occurrence of short-circuit in the cable, for example, as caused by foreign matter, deformation of the connector device, or due to increase of resistance of components adjacent to the cable, and the terminal protection module 440 provided in the body housing 410 disconnects the electrical connection between the body housing 410 and the cable simultaneously with sensing the high temperature.

That is, since the terminal protection module 440 is capable of determining whether heat is generated in an accurate and immediate manner, potential fire that may otherwise be caused by the high temperatures that are generated is avoided, thereby ensuring user safety. Accordingly, damage to the connector device 400 is prevented, and a charger can be more safely used to charge the electronic device 10.

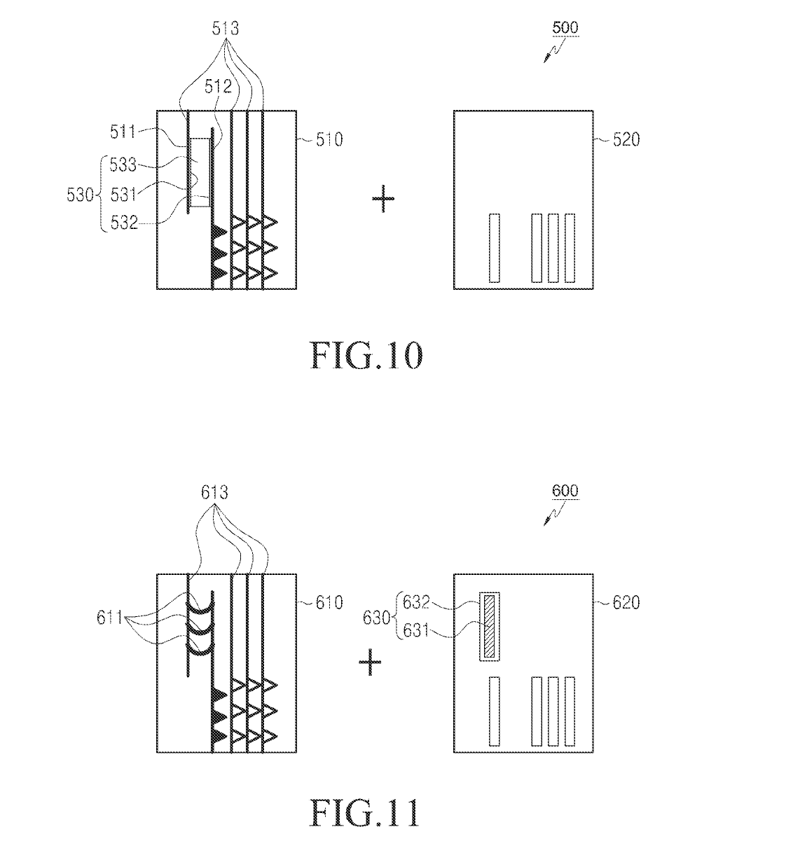

Hereinafter, descriptions will be made on a connector device according to other embodiments of the present disclosure with reference to FIG. 10. In describing the connector device according to the other embodiments, descriptions on configurations overlapping with those of the connector device 100 according to the above-described embodiment of the present disclosure will be omitted and only the different configurations will be described.

FIG. 10 illustrates an embodiment of a connector device 500 used by being connected to the electronic device 10 includes a body housing 510, a cap unit 520, and a cable. The body housing 510 is provided with a contact connector to electrically connect with a coupling terminal provided in the electronic device 10 (FIG. 1), and is provided with a plurality of connection lines 513 that are electrically connected with the cap unit 520 and the cable. The plurality of connection lines 513 are provided with first and second contact terminals 511 and 512 to be electrically connected with first and second connection terminals 531 and 532 provided on opposite faces of the terminal protection module 530 to be described later.

Further to the description provided above in regards to FIGS. 3 and 4, the cable is inserted into the cap unit 520, and the cap unit 520 coupled with the cable is fitted and coupled to the body housing 510.

Opposite faces of the terminal protection module 530 are provided with the first and second connection terminals 531 and 532 electrically connected with the first and second contact terminals 511 and 512. The terminal protection module 530 is provided in the body housing 510 to sense the temperature of the excess heat generated in the body housing 510, to cut off the electrical connection.

The terminal protection module 530 includes a terminal protection element 533 that senses temperature and heat generated from the connector device 500 and cuts off the electrical connection of the first and second connection terminals 531 and 532 at the same time.

That is, the first and second connection terminals 531 and 532 are provided on the opposite faces of the terminal protection element 533 to be coupled between the first and second contact terminals 511 and 512, and electrically connect thereto.

In addition, the first and second contact terminals 511 and 512 are formed as connection pins to electrically connect with the first and second connection terminals 531 and 532 of the terminal protection module 530. The present embodiment is described assuming that the first and second contact terminals 511 and 512 are formed as the connection pins as an example, but is not limited thereto. That is, the first and second contact terminals 511 and 512 may be applied as modified embodiments as long as they are electrically connected with the first and second connection terminals 531 and 532, despite having a different configuration.

The terminal protection module 530 senses the temperature of the body housing 510 and cuts off the electrical connection to avoid damage to the connector device 500 and occurrence of a short circuit of the connector device, thereby improving reliability.

In FIG. 10, the terminal protection module 530 is arranged in the longitudinal direction of the body housing 510, with the first and second connection terminals 531 and 532 provided on opposite faces of the terminal protection module, which is inserted between the first and second contact terminals 511 and 512 and plane-adhered thereto to be electrically connected.

That is, the terminal protection module 530 is fitted and coupled between the first and second contact terminals 511 and 512, and at this time, the first and second connection terminals 531 and 532 provided on the opposite faces of the terminal protection module 530 come in plane-contact with the first and second contact terminals 511 and 512. In this state, the first and second contact terminals 511 and 512 and the first and second connection terminals 531 and 532 are attached to each other by soldering.

The cable is inserted into the cap unit 520. The cap unit 520, into which the cable is inserted, is fitted and coupled to the body housing 510. At this time, the cap unit 520 is coupled to the body housing 510 in a press-fitting manner.

Hereinafter, descriptions are provided of a connector device 600 according to another embodiment of the present disclosure with reference to FIG. 11. In describing the connector device 600, descriptions on configurations overlapping with those of the connector device 100 according to the above-described embodiments of the present disclosure will be omitted and only the different configurations will be described.

As illustrated in FIG. 11, a connector device 600 used by being connected to the electronic device 10 includes a body housing 610, a cap unit 620, and a cable. The body housing 610 is provided with a contactor connector electrically connected with a coupling terminal provided in the electronic device 10 (FIG. 1), and is provided with a plurality of connection lines 613 that are electrically connected with the cap unit 620 and the cable. The plurality of connection lines 613 are provided with a plurality of contact terminals 611 to electrically connect the connection terminal 631 provided in the terminal protection module 630 and the connection lines 613.

The cable is inserted into the cap unit 620, and the cap unit 620 coupled with the cable is fitted and coupled to the body housing 610.

The terminal protection module 630 is provided with the connection terminal 631 electrically connected with the plurality of contact terminals 611 and provided in the cap unit 620 to sense temperature and heat generated when the body housing 610 and the cable are electrically connected with each other and to cut off the electrical connection to the plurality of contact terminals 611 at the same time.

The terminal protection module 630 includes a terminal protection element 632 to sense the temperature of heat generated from the connector device 600 and to cut off the electrical connection of each of the plurality of contact terminals 611 at the same time.

As illustrated in FIG. 11, the terminal protection module 630 is arranged in the longitudinal direction of the cap unit 620. The contact terminals 611 are formed as clip-type contact terminals to be electrically connected with the connection terminal 631 of the terminal protection module 630.

Assembly and operation of the connector device of FIG. 11 corresponds to that described above, and is omitted for conciseness.

While the present disclosure has been shown and described with reference to certain embodiments thereof, it will be apparent to those skilled in the art that the camera lens module according to the present disclosure is not limited to these embodiments, and various changes in form and details may be made therein without departing from the spirit and scope of the present disclosure as defined by the appended claims.

What is claimed is:

1. A connector device connectable to an electronic device, the connector device comprising:
a body housing;
a cap unit coupled to the body housing;
a cable electrically connected to the body housing and the cap unit; and
a terminal protection module,
wherein the terminal protection module senses a temperature due to heat generated when the body housing and the cable are electrically connected, and disconnects the electrical connection.

2. The connector device of claim 1, wherein the terminal protection module comprises:
first and second connection terminals electrically connected with first and second contact terminals provided in the body housing when the cap unit is coupled to the body housing; and
a terminal protection element provided between the first and second connection terminals,
wherein the terminal protection element senses a temperature due to heat generated when the first and second contact terminals and the first and second connection terminals are electrically connected with each other.

3. The connector device of claim 1, wherein the terminal protection module is provided in the body housing.

4. A connector device connectable to an electronic device, the connector device comprising:
a body housing provided with first and second contact terminals;
a cap unit coupled to the body housing; and
a cable electrically connected to the body housing and the cap unit,
wherein the cap unit is provided with a terminal protection module that includes first and second connection terminals electrically connected with the first and second contact terminals, and
wherein the terminal protection module senses a temperature due to heat generated when the body housing and the cable are electrically connected and disconnects the electrical connection.

5. The connector device of claim 4, wherein the terminal protection module comprises: first and second connection terminals electrically connected with the first and second contact terminals when the cap unit is coupled to the body housing; and
a terminal protection element provided between the first and second connection terminals to sense the temperature of due to heat generated by the electrical connection of the first and second connection terminals.

6. The connector device of claim 5, wherein the terminal protection element is formed as a positive temperature coefficient (PTC) element.

7. The connector device of claim 4, wherein the terminal protection module is provided in the cap unit.

8. The connector device of claim 4, the terminal protection module is arranged in a longitudinal direction of the cap unit.

9. The connector device of claim 4, wherein the terminal protection module is arranged in a direction perpendicular to a longitudinal direction of the cap unit.

10. The connector device of claim 4, wherein the first and second connection terminals are formed as first and second connection grooves that are fitted and coupled to first and second contact terminals provided in the body housing, and electrically connected thereto.

11. The connector device of claim 4, wherein the first and second contact terminals are formed as first and second clip-type contact terminals that are electrically connected with the first and second connection terminals of the terminal protection module.

12. A connector device connectable to an electronic device, the connector device comprising:
a body housing provided with first and second contact terminals;
a cap unit coupled to the body housing; and
a cable electrically connected the body housing and the cap unit,
wherein the body housing is provided with a terminal protection module including first and second connection terminals electrically connected with the first and second contact terminals, and
wherein the terminal protection module senses a temperature due to heat generated when the body housing and the cable are electrically connected and disconnects the electrical connection.

13. The connector device of claim 12, wherein the terminal protection module includes:
a terminal protection element provided between the first and second connection terminals, to sense the temperature of the electrical connection of the first and second connection terminals.

14. The connector device of claim 13, wherein the terminal protection element is formed as a positive temperature coefficient (PTC) element.

15. The connector device of claim 12, wherein the terminal protection module is provided in the body housing.

16. The connector device of claim 12, wherein the terminal protection module is arranged in a longitudinal direction of the body housing.

17. The connector device of claim 12, wherein the terminal protection module is arranged in a direction perpendicular to a longitudinal direction of the body housing.

18. The connector device of claim 12, wherein the first and second connection terminals are formed as first and second connection grooves that are fitted and coupled to first and second contact terminals provided in the body housing, and are electrically connected thereto.

19. The connector device of claim 12, wherein the first and second contact terminals are formed as first and second clip-type contact terminals that are electrically connected with the first and second connection terminals of the terminal protection module.

20. A connector device connectable to an electronic device, the connector device comprising:
a body housing provided with first and second contact terminals;
a cap unit coupled to the body housing; and
a cable electrically connected to the body housing and the cap unit,
wherein the body housing is provided with a terminal protection module that includes a first connection terminal and a second connection terminal on opposite faces of the terminal protection module,
wherein the terminal protection module is coupled between and electrically connected to the first and second contact terminals, and
wherein the terminal protection module senses a temperature due to heat generated when the body housing and the cable are electrically connected and disconnects the electrical connection.

21. The connector device of claim 20, further comprising:
a terminal protection element provided between the first and second connection terminals to sense a temperature due to heat generated by the electrical connection of the first and second connection terminals.

22. The connector device of claim 20, wherein the first and second contact terminals are formed as connection pins that are electrically connected with the first and second connection terminals of the terminal protection module.

23. A connector device connectable to an electronic device, the connector device comprising:
a body housing provided with a plurality of contact terminals;
a cap unit coupled to the body housing; and
a cable electrically connected to the body housing and the cap unit,
wherein the cap unit is provided with a terminal protection module that includes a connection terminal electrically connected with the plurality of contact terminals,
wherein the terminal protection module senses a temperature due to heat generated when the body housing and the cable are electrically connected, and disconnects the electrical connection.

24. The connector device of claim 23, wherein the connection terminal is electrically connected with the plurality of contact terminals when the cap unit is coupled to the body housing; and
a terminal protection element is provided between the connection terminals to sense the temperature due to heat generated by the electrical connection of the connection terminals.

25. The connector device of claim 23, wherein the plurality of contact terminals are formed as clip-type contact terminals electrically connected with the connection terminal of the terminal protection module.
